(19) United States
(12) Patent Application Publication
(10) Pub. No.: US 2014/0298147 A1
(43) Pub. Date: Oct. 2, 2014

(54) DATA TRANSFERRING SYSTEMS, DATA RECEIVERS AND METHODS OF TRANSFERRING DATA USING THE SAME

(71) Applicant: SK hynix Inc., Icheon-si (KR)

(72) Inventor: Keun Soo SONG, Icheon-si (KR)

(73) Assignee: SK hynix Inc., Icheon-si (KR)

(21) Appl. No.: 13/965,674

(22) Filed: Aug. 13, 2013

(30) Foreign Application Priority Data
Apr. 2, 2013 (KR) 10-2013-0035769

(51) Int. Cl. G06F 11/10

(52) U.S. Cl. CPC G06F 11/1004
USPC 714/807

(57) ABSTRACT

Data transferring systems are provided. The data transferring system includes a transmitter and a receiver. The transmitter transmit a reference code signal including a reference value of data, a transmission data signal generated by synthesizing data being transmitted and the reference code signal, and an external data masking signal. The receiver receives the transmission data signal to extract an internal code signal and generates an internal data masking signal in response to the internal code signal and the reference code signal. Further, the receiver generates an internal data signal from the transmission data signal in response to the external data masking signal and the internal data masking signal. Related methods are also provided.

### CROSS-REFERENCE TO RELATED APPLICATION

The present application claims priority under 35 U.S.C 119(a) to Korean Application No. 10-2013-0035769, filed on Apr. 2, 2013, in the Korean Intellectual Property Office, which is incorporated herein by reference in its entirety.

### BACKGROUND

Each data transferring system includes a transmitter for sending data to an external device and a receiver for receiving data from an external device. Recently, error detection methods using an error-detecting code such as a cyclic redundancy check (CRC) code have been widely used to ensure a successful transmission of non-erroneous data from the transmitter to the receiver. When the data are transferred from the transmitter using the CRC code, the data may include a reference value of the data which has been calculated. Further, the receiver, which receives the data, may extract the reference value from the data and may compare the extracted reference value with the calculated reference value to discriminate whether the data have errors or not.

A data masking technique may be used to store only desired bits among bits of the data outputted from the transmitter in the receiver. That is, the data transferring system may store only desired bits among the bits of the data outputted from the transmitter in the receiver using the data masking technique. In order that the data transferring system use the data masking technique, the data transmitted from the transmitter to the receiver must be provided together with a data masking signal indicating which bits are masked bits.

### SUMMARY

Various embodiments are directed to data transmission circuits.

According to an embodiment of the present invention, a data transferring system includes a transmitter and a receiver. The transmitter is configured to transmit a reference code signal including a reference value of data, a transmission data signal generated by synthesizing data being transmitted and the reference code signal, and an external data masking signal. The receiver is configured to receive the transmission data signal to extract an internal code signal, generate an internal data masking signal in response to the internal code signal and the reference code signal. In addition, the receiver generates an internal data signal from the transmission data signal in response to the external data masking signal and the internal data masking signal.

According to an embodiment of the present invention, a data receiver includes an internal control signal generator, an internal data generator and a storage unit. The internal control signal generator extracts an internal code signal from a transmission data signal and compares the internal code signal with a reference code signal to generate an internal data masking signal. The internal data generator compares the internal data masking signal with an external data masking signal to generate an internal data signal which is included in the transmission data signal. The storage unit is configured to receive the internal data.

According to an embodiment of the present invention, a method of transferring data from a transmitter to a receiver includes extracting a reference code signal including a reference value of data at the transmitter; transmitting the reference code signal, a transmission data signal generated by synthesizing the data and the reference code signal, and an external data masking signal to the receiver; extracting an internal code signal from the transmission data signal to generate an internal data masking signal in response to the internal code signal and the reference code signal at the receiver; and generating an internal data signal from the transmission data signal in response to the internal data masking signal and the external data masking signal.

### BRIEF DESCRIPTION OF THE DRAWINGS

Embodiments of the inventive concept will become more apparent in view of the attached drawings and accompanying detailed description, in which:

FIG. 1 is a block diagram illustrating a configuration of a data transferring system according to an embodiment of the present invention;

FIG. 2 is a block diagram illustrating a configuration of an internal control signal generator included in the data transferring system of FIG. 1; and

FIG. 3 is a schematic view illustrating a configuration of an internal data generator included in the data transferring system of FIG. 1.

### DETAILED DESCRIPTION

Example embodiments of the inventive concept will be described hereinafter with reference to the accompanying drawings. However, the example embodiments described herein are for illustrative purposes only and are not intended to limit the scope of the inventive concept.

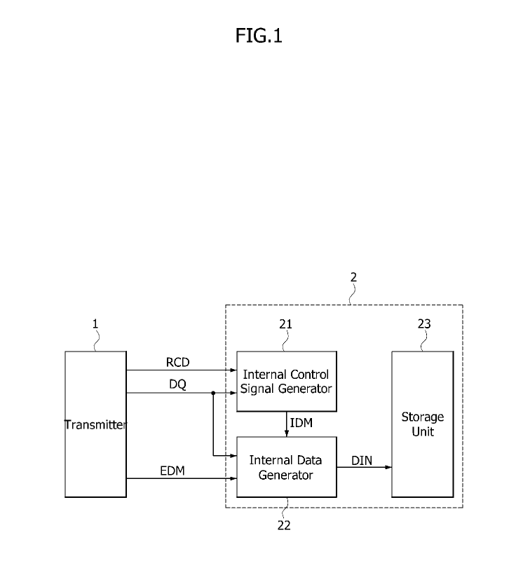

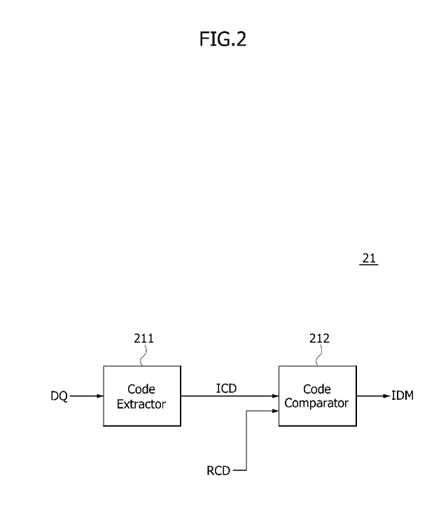

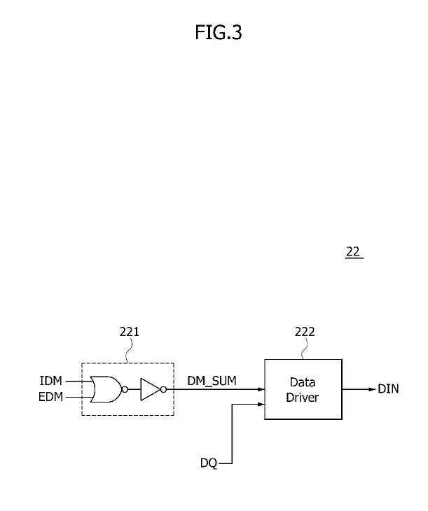

Referring to FIG. 1, a data transferring system according to an embodiment of the present invention may be configured to include a transmitter 1 and a receiver 2. In an embodiment of the present invention, the transmitter 1 may calculate a reference value of data (not shown) using a CRC code to extract a reference code signal RCD corresponding to the reference value. In an embodiment of the present invention, data transferring system may include a calculating unit (not shown) which calculates a reference value of data using a CRC code to provide calculated reference value of data. Further, the transmitter 1 may send a transmission data signal DQ, which is generated by synthesizing the data and the reference code signal RCD, to the receiver 2 together with the reference code signal RCD and an external data masking signal EDM. The transmission data signal DQ may include bits corresponding to the data and bits corresponding to the reference code signal RCD. The external data masking signal EDM may be enabled and transferred from the transmitter 1 to the receiver 2 when a data masking operation is required to prevent the data included in the transmission data signal DQ from being stored in a storage unit of the receiver 2. The receiver 2 may be configured to include an internal control signal generator 21, an internal data generator 22 and a storage unit 23. The internal control signal generator 21 may be configured to receive the reference code signal RCD and the transmission data signal DQ and generate an internal data masking signal IDM. In an embodiment of the present invention, the internal control signal generator 21 may extract an internal code signal (not shown) from the bits corresponding to the reference code signal RCD included in the transmission data signal DQ and may compare the internal code signal with the reference code signal RCD to generate the internal data masking signal IDM. The internal data generator 22 may compare the internal data masking signal IDM with the external data masking signal EDM to control a drivability of an internal data signal DIN which is included in the transmission data signal DQ and is applied to the storage unit 23. Detailed configurations and operations of the internal control signal generator 21 and the internal data generator 22 will be described hereinafter with reference to FIGS. 2 and 3.

Referring to FIG. 2, the internal control signal generator 21 may configured to include a code extractor 211 and a code comparator 212. The code extractor 211 may output an internal code signal ICD in response to the transmission data signal DQ. In an embodiment of the present invention, the code extractor 211 may extract an internal code signal ICD from the bits corresponding to the reference code signal RCD included in the transmission data signal DQ. In an embodiment of the present invention, which bits correspond to the data and which bits correspond to the reference code signal RCD among the transmission data signal DQ may be determined by the transmitter 1 as described above. The code comparator 212 may compare the internal code signal ICD extracted from the transmission data signal DQ with the reference code signal RCD transferred from transmitter 1 to generate the internal data masking signal IDM. Specifically, the code comparator 212 may generate the internal data masking signal IDM disabled to have a logic “low” level when the internal code signal ICD is identical to the reference code signal RCD; and the code comparator 212 may generate the internal data masking signal IDM enabled to have a logic “high” level when the internal code signal ICD is different from the reference code signal RCD. If the internal code signal ICD is different from the reference code signal RCD, it means that the transmission data signal DQ includes errors which are created due to various interface factors when the transmission data signal DQ is transferred from the transmitter 1 to the receiver 2. What logic level the enabled internal data masking signal IDM will have may vary according to various embodiments of the present invention.

Referring to FIG. 3, the internal data generator 22 may be configured to include a synthesizer 221 and a data driver 222. The synthesizer 221 may generate a synthesized data masking signal DM_SUM which is enabled to have a logic “high” level when at least one of the internal data masking signal IDM and the external data masking signal EDM is enabled to have a logic “high” level. The data driver 222 may drive the internal data signal DIN using the data included in the transmission data signal DQ when the synthesized data masking signal DM_SUM is disabled to have a logic “low” level, and the data driver 222 does not drive the internal data signal DIN when the synthesized data masking signal DM_SUM is enabled to have a logic “high” level. That is, when at least one of the internal data masking signal IDM and the external data masking signal EDM is enabled to a logic “high” level, the internal data generator 22 does not drive the internal data signal DIN and therefore the data included in the transmission data signal DQ may be prevented from being stored in the storage unit 23.

Hereinafter, an operation of the data transferring system as set forth above will be described with reference to FIGS. 1, 2 and 3.

First, the transmitter 1 illustrated in FIG. 1 may calculate a reference value of data (not shown) using a CRC code to extract a reference code signal RCD corresponding to the reference value. Further, the transmitter 1 may send a transmission data signal DQ, which is generated by synthesizing the data and the reference code signal RCD, to the receiver 2 together with the reference code signal RCD and an external data masking signal EDM by wireless or cable. The transmission data signal DQ may include bits corresponding to the data and bits corresponding to the reference code signal RCD. The external data masking signal EDM may be enabled and transferred from the transmitter 1 to the receiver 2 when a data masking operation is required to prevent the data included in the transmission data signal DQ from being stored in the storage unit 23 of the receiver 2.

Next, the internal control signal generator (21 of FIG. 2) included in the receiver 2 may compare an internal code signal ICD extracted from the transmission data signal DQ with the reference code signal RCD transferred from transmitter 1 to generate an internal data masking signal IDM. In such a case, the internal control signal generator 21 may generate an internal data masking signal IDM disabled to have a logic “low” level when the internal code signal ICD is identical to the reference code signal RCD, and the internal control signal generator 21 may generate the internal data masking signal IDM enabled to have a logic “high” level when the internal code signal ICD is different from the reference code signal RCD.

Finally, when at least one of the internal data masking signal IDM and the external data masking signal EDM is enabled, the internal data generator (22 of FIG. 3) included in the receiver 2 does not drive an internal data signal DIN and therefore the data included in the transmission data signal DQ may be prevented from being stored in the storage unit 23.

As described above, the data transferring system according to an embodiment of the present invention may generate the internal data masking signal IDM, which is internally enabled, to execute a data masking operation that prevents erroneous data from being stored in the storage unit 23 in the event that errors are created when the transmission data signal DQ is transferred from the transmitter 1 to the receiver 2. In order to prevent the data included in the transmission data signal DQ from being stored in the storage unit 23, the receiver 2 may receive the external data masking signal EDM outputted from the transmitter 1 to execute the data masking operation without use of any additional circuits.

The example embodiments of the inventive concept have been disclosed above for illustrative purposes. Those skilled in the art will appreciate that various modifications, additions and substitutions are possible, without departing from the scope and spirit of the inventive concept as disclosed in the accompanying claims.

What is claimed is:

1. A data transferring system comprising:
a transmitter configured to transmit a reference code signal including a reference value of data, a transmission data signal generated by synthesizing data being transmitted and the reference code signal, and an external data masking signal; and
a receiver configured to receive the transmission data signal to extract an internal code signal, generate an internal data masking signal in response to the internal code signal and the reference code signal, and generate an internal data signal from the transmission data signal in response to the external data masking signal and the internal data masking signal.

2. The data transferring system of claim 1, wherein the transmitter calculates the reference value from the data using a cyclic redundancy check (CRC) code.

3. The data transferring system of claim 1, wherein the transmission data signal includes bits corresponding to the data and bits corresponding to the reference code signal.

4. The data transferring system of claim 1, wherein the receiver includes an internal control signal generator configured to extract the internal code signal from the transmission data signal and configured to compare the internal code signal with the reference code signal to generate the internal data masking signal.

5. The data transferring system of claim 4, wherein the internal control signal generator includes:
a code extractor configured to extract the internal code signal from at least one bit included in the transmission data signal and configured to output the internal code signal; and
a code comparator configured to generate the internal data masking signal which is enabled when the internal code signal is different from the reference code signal.

6. The data transferring system of claim 4, wherein the receiver further includes an internal data generator configured to compare the internal data masking signal with the external data masking signal to generate an internal data signal which is included in the transmission data signal and a storage unit configured to receive the internal data.

7. The data transferring system of claim 6, wherein the internal data generator includes:
a synthesizer configured to receive the internal data masking signal and the external data masking signal to generate a synthesized data masking signal; and
a data driver configured to drive the internal data signal from the transmission data signal in response to the synthesized data masking signal.

8. The data transferring system of claim 7, wherein the synthesizer generates the synthesized data masking signal when at least one of the internal data masking signal and the external data masking signal is enabled.

9. A data receiver comprising:
an internal control signal generator configured to extract an internal code signal from a transmission data signal and configured to compare the internal code signal with a reference code signal to generate an internal data masking signal;
an internal data generator configured to compare the internal data masking signal with an external data masking signal to generate an internal data signal which is included in the transmission data signal; and
a storage unit configured to receive the internal data.

10. The data receiver of claim 9, wherein the transmission data signal includes a reference value calculated from data using a cyclic redundancy check (CRC) code and the data.

11. The data receiver of claim 10, wherein the transmission data signal includes bits corresponding to the data and bits corresponding to the reference code signal.

12. The data receiver of claim 11, wherein the reference code signal includes bits corresponding to the reference value.

13. The data receiver of claim 9, wherein the internal control signal generator includes:
a code extractor configured to extract the internal code signal from at least one bit included in the transmission data signal and configured to output the internal code signal; and
a code comparator configured to generate the internal data masking signal which is enabled when the internal code signal is different from the reference code signal.

14. The data receiver of claim 9, wherein the internal data generator includes:
a synthesizer configured to receive the internal data masking signal and the external data masking signal to generate a synthesized data masking signal; and
a data driver configured to drive the internal data signal from the transmission data signal in response to the synthesized data masking signal.

15. The data receiver of claim 14, wherein the synthesizer generates the synthesized data masking signal when at least one of the internal data masking signal and the external data masking signal is enabled.

16. A method of transferring data from a transmitter to a receiver, the method comprising:
extracting a reference code signal including a reference value of data at the transmitter;
transmitting the reference code signal, a transmission data signal generated by synthesizing the data and the reference code signal, and an external data masking signal to the receiver;
extracting an internal code signal from the transmission data signal to generate an internal data masking signal in response to the internal code signal and the reference code signal at the receiver; and
generating an internal data signal from the transmission data signal in response to the internal data masking signal and the external data masking signal.

17. The method of claim 16, wherein the reference value is extracted from the data using a cyclic redundancy check (CRC) code.

18. The method of claim 16, wherein the transmission data signal includes bits corresponding to the data and bits corresponding to the reference code signal.

19. The method of claim 16, wherein extracting the internal code signal to generate the internal data masking signal includes:
extracting the internal code signal from at least one bit included in the transmission data signal to output the internal code signal; and
generating the internal data masking signal which is enabled when the internal code signal is different from the reference code signal.

20. The method of claim 16, wherein generating the internal data signal includes:
generating a synthesized data masking signal in response to the internal data masking signal and the external data masking signal; and
driving the internal data signal from the transmission data signal in response to the synthesized data masking signal.
